(19) United States
(12) Patent Application Publication
(10) Pub. No.: US 2009/0180599 A1
(43) Pub. Date: Jul. 16, 2009

(54) System and Method for Delivering Targeted Promotional Announcements Over a Communications Network

(75) Inventors: Richard Jackowitz, Warwick, NY (US); Jack Lehmann, Spring Valley, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: BRANDED MARKETING LLC, Haskell, NJ (US)

(21) Appl. No.: 12/014,413

(22) Filed: Jan. 15, 2008

(51) Int. Cl. H04M 11/00

(52) U.S. Cl. 379/93.12

(57) ABSTRACT

A method for delivering targeted promotional announcements comprising: associating a financial card account with a subscriber; receiving an instruction to connect a call from the subscriber to a called party; selecting a promotional announcement from a plurality of promotional announcements based on information derived from the financial card account; delivering the promotional announcement to the subscriber; and connecting the subscriber to the called party.

### FIELD OF THE INVENTION

The present invention relates generally to providing promotional announcements over a communications network and, more particularly, to providing free or discounted communication services in exchange for listening to a promotional announcement.

### BACKGROUND OF THE INVENTION

Telecommunications services may be subsidized through the use of promotional announcements. For example, free or discounted telecommunications services may be offered to consumers that listen to a promotional announcement before the call is connected. Some prior art systems are configured to target consumers with relevant offers but, unfortunately, they have limited intelligence on the caller's preferences. For example, telecommunications carriers may only have information about a consumer's age, gender, and location. In part as a result of weak targeting, consumers may be unwilling to use these systems if the offers are for a general audience, or only slightly targeted, or if they rely on a proportionally high amount of advertising time. Embodiments of the present invention address, among other things, these competing needs.

### SUMMARY OF THE INVENTION

Embodiments of the present invention relate to a system and method for delivering targeted promotional announcements over a communications network based on a subscribing consumer's use of a financial card, such as debit or open system stored value card, and a calling account. In an embodiment, if the subscriber makes a call using a mobile device associated with the calling account, embodiments of the present invention can deliver a targeted promotional announcement to the subscriber before connecting the subscriber to a called party. The targeted promotional announcement may be selected from a plurality of promotional announcements based on the subscriber's prior purchases using the financial card.

In one aspect of the invention, a method for processing incoming calls includes associating a financial card account with a subscriber; receiving an instruction to connect a call from the subscriber to a called party, wherein the call is made from a mobile device associated with the subscriber; selecting a promotional announcement from a plurality of promotional announcements based on information derived from the financial card account; delivering the promotional announcement to the subscriber; and connecting the subscriber to the called party.

In another aspect of the invention, a method for processing incoming calls includes receiving an authorization to deliver a promotional announcement in connection with incoming calls directed to a subscriber; receiving an instruction to connect a call to the subscriber from a non-subscriber, wherein the call is directed to a mobile device associated with the subscriber; selecting a promotional announcement from a plurality of promotional announcements; delivering the promotional announcement to the non-subscriber; and connecting the non-subscriber to the subscriber.

In another aspect of the invention, a system for delivering promotional announcements includes a store value card account associated with a calling party; a calling account associated with the calling party; a mobile device associated with the calling account; a consumer profile database for retrievably storing a subscriber profile, wherein the subscriber profile includes information derived from the financial card account; an ad database for retrievably storing a plurality of promotional announcements; a switch in communication with the mobile device, the consumer profile database and the ad database; a server configured to select a promotional announcement among the plurality of promotional announcements based on information in the consumer profile database and to deliver the promotional announcement to the calling party via the switch; and wherein the switch is configured to receive a call made from the mobile device, deliver the promotional announcement to the mobile device, and connect the calling party to a called party.

### BRIEF DESCRIPTION OF THE DRAWINGS

Embodiments and other aspects of the present invention will be readily apparent from the detailed description below and the attached drawings, which are meant to illustrate and not to limit the invention, wherein:

FIG. 1 is a functional block diagram that illustrates the components of an exemplary system for practicing an embodiment of the present invention;

FIG. 2 is a process diagram of an exemplary method for delivering promotional announcements to a subscriber according to an embodiment of the present invention; and

FIG. 3 is a process diagram of an exemplary method for delivering promotional announcements to a non-subscriber that calls a subscriber according to an embodiment of the present invention.

### DESCRIPTION

Embodiments of the present invention may involve novel methods and/or apparatus for improving targeted advertising. The following description is presented to enable one skilled in the art to make and use the invention, and is provided in the context of particular applications and their requirements. In that regard, the following description of embodiments is not intended to be exhaustive or to limit the present invention to the precise form disclosed. For example, although a series of acts may be described with reference to a flow diagram, the order of acts may differ in other implementations when the performance of one act is not dependent on the completion of another act. Further, non-dependent acts may be performed in parallel. It should also be understood that elements and/or features of a composition, an apparatus, or a method described herein can be combined in a variety of ways without departing from the spirit and scope of the present teachings, whether explicit or implicit herein.

An embodiment of the present invention relates to a system and method for delivering targeted promotional announcements over a communications network to a subscriber based on the subscriber's use of a financial card, such as debit or open system financial card. For example, if the subscriber makes a call using a mobile device associated with the calling account, embodiments of the present invention can deliver a targeted promotional announcement to the subscriber before connecting the subscriber to a called party. The targeted promotional announcement may be selected from a plurality of promotional announcements based on, but not limited to, the subscriber's prior purchases using the financial card. For example, an embodiment of the present invention may deliver an advertisement related to a sale on fishing rods at a local sporting goods store if the subscriber recently used the financial card to purchase fishing equipment. Those skilled in the art will appreciate that the subscriber's prior purchasing history may be combined with other identifiable characteristics including, but not limited to, gender, age and location to select a targeted promotional announcement.

In the following discussion of illustrative embodiments, the term “database,” as used in this description, may be any body of information that is logically organized so that it can be retrieved, stored and searched in a coherent manner. The term “calling party” is used in this description generally to refer to the person or unit that initiates a communication. The calling party may also be referred to herein as “caller.” The term “announcement,” as used herein, refers to a text message, a sound recording, or a video recording that may be delivered or played back to a subscriber or non-subcriber to impart information. Examples of announcements can include, but are not limited to: commercials, promotions, public service announcements (PSAs), weather alerts, news alerts, infomercials, instruction recordings, and the like. The terms “financial card” and “financial instrument” are used interchangeably herein to mean any portable object associated with a financial account including credit cards, debit cards, stored value cards, gift cards, and contactless devices (e.g., a bank association branded card including, but not limited to Visa, MasterCard, American Express, Diner's Club and Discover). A “financial card,” for example, may be associated with information about prior purchases and, or alternatively, information about monies that have been prepaid into an account, including but not limited to open system stored value and debit, for the purpose of making a financial transaction. The term “card” is used herein to refer to any portable object associated with a financial account including cards and other objects with a magnetic strip, contactless devices such as, but not limited to, fobs, chip enabled smart cards, mobile transmitters, mobile devices, 2D Code readers, physical world connection readers, and radio frequency identification transmitters. The term “subscriber” refers to a party that can receive a targeted promotional announcement based on historical financial data derived from the subscriber's financial account. The term “non-subscriber” refers to a party that can receive a promotional announcement, although not targeted using information derived from a financial account according to the present teachings. The phrases “made by” or “directed to” refer to a call that involves a mobile device or handset associated with the calling account of the present teachings.

It is to be understood that the figures and descriptions of the present invention have been simplified to illustrate elements that are relevant for a clear understanding of the present invention while eliminating, for purposes of clarity, other elements. For example, certain details relating to cellular networks or the hardware elements installed in such a network are not described herein. A discussion of such elements is not provided because such elements are well known in the art and because they do not facilitate a better understanding of the present invention and because embodiments of the present invention may be implemented using a telecommunications service provider's existing hardware by making appropriate software upgrades.

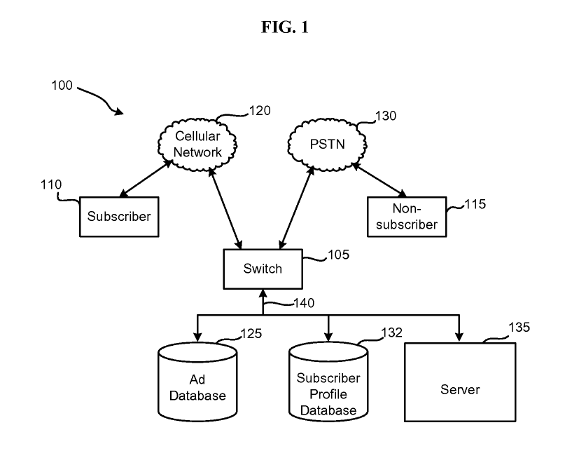

FIG. 1 is a schematic diagram of an exemplary system 100 for delivering targeted promotional announcements over a telecommunications network according to an embodiment of the present invention. In the illustrated embodiment, system 100 includes a switch 105 in communication with a subscriber 110 and a non-subscriber 115 over a cellular network 120 and a public-switched telephone network 130. Switch 105 communicates with an advertisement database 125, a subscriber profile database 132, and a terminating routing server 135 over a network 140. In alternative embodiments, the functions performed by one of the functional blocks illustrated in FIG. 1 may be performed by or combined with another functional block. For example, subscriber profile database 132 may perform the functions of both subscriber profile database 120 and ad database 125. Likewise, switch 105 may perform the functions of server 135. The relationships between the functional blocks may also be modified without departing from the principles of the present invention. For example, ad database 125 and/or subscriber profile database 132 may be connected directly to server 135, rather than network 140, so that server 135 serves as a front end to ad database 125 and/or subscriber profile database 132.

Switch 105 may be configured to manage communications between subscriber 110 and non-subscriber 115 in accordance with embodiments of the present invention. In some embodiments, switch 105 may be implemented as a mobile programmable switch or any other switch that processes calls originated from or destined to a cellular network. Switch 105 may be implemented using, for example, a cellular switch such as the Nortel DMS MTX available from Nortel Networks, the 5ESS 2000 available from Alcatel-Lucent, or the R4 GSM available from Nokia. Switch 105 may be configured to receive a call made by subscriber 110 so that a promotional announcement can be delivered to subscriber 110 before connecting subscriber 110 to a called party. Switch 105 may also be configured to receive a call directed to subscriber 110, such as by non-subscriber 115, so that a promotional announcement can be delivered to non-subscriber 115 before connecting non-subscriber 115 to subscriber 110. Switch 105 may also include account management capability for tracking and billing subscriber usage.

Ad database 125 is a searchable storage entity that may be configured to store and serve a plurality of announcements such as audio, video, text, and/or graphic format advertisements associated with participating merchants. Announcements may be sold in a block or on a “per spot” basis. A block of advertising time refers to the purchase of an advertisement played a certain number of times over a defined period (e.g., an 8 week, $250,000 block). A “per spot” basis refers to the purchase of a single play of an advertisement (e.g., $0.45/spot). Spot pricing may vary based on the time of day a call is made, the total call volume within the system during that specific call, and the consumer's level of participation.

Subscriber profile database 132 is a searchable storage entity that may be configured to store a plurality of subscriber profiles. According to an embodiment, subscriber profile database 132 may include information about subscriber preferences, purchasing trends, locations, average purchase price over a certain time period (e.g., 30 days), time of year, age, and gender of the consumer. In other embodiments, subscriber profile database 132 may include a spending history of subscriber 110 based on his or her use of the financial card. Subscriber profile database 132 may also include, according to an embodiment, information about the call history of subscriber 110 including the types of businesses the subscriber calls regularly. Consumer profiles are well known in the art and can include a wide variety of information relating to individual consumers.

Server 135 may be configured to control the delivery of promotional announcements to switch 105 according to one or more embodiments of the present invention. In some embodiments, server 135 is a terminating routing server. Server 135 may be configured to deliver a targeted promotional announcement to subscriber 110 before switch 105 connects to subscriber 110 to the called party. In an embodiment, the announcement is a 7-10 second promotional advertisement selected at random. In other embodiments, the targeted promotional announcement may be selected from ad database 125 based on information about subscriber 110 in consumer profile database 132. According to an embodiment, server 135 may be configured to select announcements of local and regional advertisers based on the residential zip code and/or area code of calling party 110, a practice known as “Geo-Targeting.” Server 135 may also be adapted to maintain a log of promotional announcements delivered, such as by subscriber.

Alternatively, or in addition, server 135 may be configured to deliver a promotional announcement to a non-subscriber, such as non-subscriber 115, if non-subscriber 115 directs a call to subscriber 110. In an embodiment, server 135 may be configured to deliver a promotional announcement to non-subscriber 115 before switch 105 connects non-subscriber 115 to subscriber 110. Promotional announcements delivered to a non-subscriber may be created for a general audience or targeted in ways that do not rely on a consumer spending history derived from a financial account. For example, a Geo-Targeted promotional announcement may be delivered to non-subscriber 115. In another example, the promotional announcement delivered to non-subscriber 115 may include an advertisement for a calling account and the communications services described herein, such as “Did you know you could be making this call for free? All you need is the MoneyCard. Call 1-888-Moneycard.”

Server 135 may be configured to receive and process responses input during a call either made by or directed to subscriber 110 according to an embodiment of the present invention. In response to input from a calling party, such as subscriber 110, an embodiment of server 135 may be used to connect subscriber 110 to an advertiser via switch 105. For example, if subscriber 110 frequently rents cars, the promotional message may include an invitation that states, “To be connected to Hertz reservations, press 1.” If subscriber 110 presses “1,” he or she will be connected to the advertiser. Upon terminating the connection with the advertiser, system 100 may be configured to connect the initial call made by subscriber 110, such as by recalling the dialed number from memory. According to an embodiment, server 135 may receive a signal or wink from switch 105 indicating the advertising process is complete.

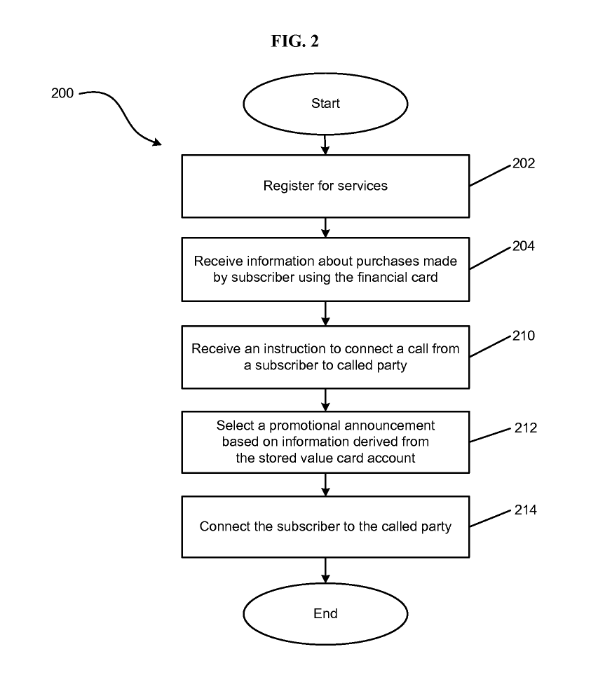

FIG. 2 is a process diagram of an exemplary method 200 for delivering promotional announcements over a telecommunications network according to an embodiment of the present invention. According to an embodiment, method 200 begins in step 202 when subscriber 110 registers for the services described herein. According to one or more embodiments, step 202 may include opening and funding a financial account and transferring a plurality of calling minutes to a new or existing calling account. In some embodiments, the calling account may be linked to the financial account as a secondary funding source for the calling account in the event the calling account balance is overdrawn. Step 202 may also include, if necessary, providing or activating a mobile device or any other act that allows subscriber 110 to make calls from the mobile device. Registration services, such as providing or activating a mobile device, may be accomplished using a variety of known methods, such as via telephone, email, fax, mobile text message, web portal, mail, retail location, self-serve kiosk, or in-person. Upon completing step 202, subscriber 110 may be ready to make calls using the handset.

In step 204, for each purchase that subscriber 110 makes using the financial card, information about the transaction may be collected and stored in subscriber profile database 132, which may include, for example, the merchant category code (MCC) and the merchant name. For example, subscriber 110 may use the financial card to purchase artificial lures from Modell's. Funds may be added to the financial account using a variety of known methods, such as direct deposit, point of sale merchant and retail cash reload networks, participating bank branch cash reloads (such as via an automated teller machine or financial self-serve kiosk), card to card (internal system) transfers, advertiser minute giveaway promotions and wire transfers.

In step 210, an instruction is received that indicates subscriber 100 desires to make a call, such as if subscriber 110 dials a telephone number for a called party using the mobile device activated in step 202. In steps 212 and 213, method 200 delays connecting subscriber 110 to the called party to select and deliver a promotional announcement to subscriber 110, such as from ad database 125. The promotional announcement may be selected, for example, based on the subscriber's purchases from any retailer that accepts the financial card, including those unrelated to the called party. In some embodiments, the actions or non-actions of subscriber 110 with respect to the delivered promotional announcement may be stored, such as in subscriber profile database 132.

In step 214, subscriber 110 is connected to the called party. In some embodiments, the call may be connected only if the balance of calling minutes is greater than zero. In that regard, step 214 may include monitoring the connection time and comparing the elapsed time to the remaining calling minutes. In some embodiments, if the connection time exceeds the balance of calling minutes, overage fees may be withdrawn from the associated financial account. For example, subscriber 110 may elect to identify a backup funding source to cover overage fees, such as by interacting with an interactive voice response system during account registration.

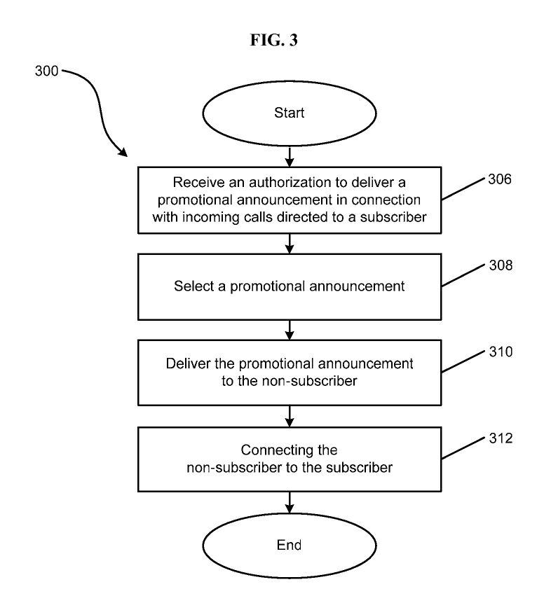

FIG. 3 is a process diagram of an exemplary method 300 for delivering promotional announcements to a non-subscriber that directs a call to a subscriber according to an embodiment of the present invention. In step 306, an instruction is received indicating subscriber 110 has in incoming call. Step 306 is similar in many respects to step 210 of method 200 except that in step 306 the call is directed to, rather than made by, subscriber 110. In steps 308 and 310, method 300 delays connecting non-subscriber 115 to the subscriber 110 to select and deliver a promotional announcement to subscriber 110, such as from ad database 125. Steps 308 and 310 are similar in many respects to steps 208 and 210 of method 200 except that steps 308 and 310 select and deliver promotional announcements based on criteria other than a purchase history derived from the financial card. In step 312, non-subscriber 115 is connected to subscriber 110.

The present teachings can be embodied in other specific forms, not delineated above, without departing from the spirit or essential characteristics thereof. The foregoing embodiments are therefore to be considered in all respects illustrative rather than limiting on the present teachings described herein. Scope of the present invention is thus indicated by the appended claims rather than by the foregoing description, and all changes that come within the meaning and range of equivalency of the claims are intended to be embraced therein.

1. A method for delivering targeted promotional announcements comprising:
associating a financial card account with a subscriber;
receiving an instruction to connect a call from the subscriber to a called party, wherein the call is made from a mobile device associated with the subscriber;
selecting a promotional announcement from a plurality of promotional announcements based on information derived from the financial card account;
delivering the promotional announcement to the subscriber; and
connecting the subscriber to the called party.

2. The method of claim 1 further comprising,
transferring a plurality of calling minutes to the subscriber.

3. The method of claim 2 further comprising,
maintaining the connection between the subscriber and the called party if the plurality of calling minutes is greater than zero.

4. The method of claim 1 wherein the promotional announcement includes audio.

5. The method of claim 1 wherein the promotional announcement includes a text message.

6. The method of claim 1 wherein the promotional announcement includes video.

7. The method of claim 1 wherein the financial card account is an open system stored value account.

8. The method of claim 1 wherein receiving an instruction includes identifying the subscriber based on a caller ID.

9. The method of claim 1 further comprising,
debiting the financial card account if the connection has a duration that exceeds the plurality of calling minutes.

10. The method of claim 1 further comprising,
subtracting time from the plurality of calling minutes while the connection is maintained; and
maintaining the connection between the subscriber and the called party while the plurality of calling minutes is greater than zero.

11. A method for processing incoming calls comprising:
receiving an authorization to deliver a promotional announcement in connection with incoming calls directed to a subscriber;
receiving an instruction to connect a call to the subscriber from a non-subscriber, wherein the call is directed to a mobile device associated with the subscriber;
selecting a promotional announcement from a plurality of promotional announcements;
delivering the promotional announcement to the non-subscriber; and
connecting the non-subscriber to the subscriber.

12. The method of claim 11 further comprising transferring a value to the subscriber.

13. The method of claim 12 wherein the value is the plurality of calling minutes.

14. A system for delivering promotional announcements comprising:
a store value card account associated with a calling party;
a calling account associated with the calling party;
a mobile device associated with the calling account;
a consumer profile database for retrievably storing a subscriber profile, wherein the subscriber profile includes information derived from the financial card account;
an ad database for retrievably storing a plurality of promotional announcements;
a switch in communication with the mobile device, the consumer profile database and the ad database;
a server configured to select a promotional announcement among the plurality of promotional announcements based on information in the consumer profile database and to deliver the promotional announcement to the calling party via the switch; and
wherein the switch is configured to receive a call made from the mobile device, deliver the promotional announcement to the mobile device, and connect the calling party to a called party.

15. The system of claim 14 wherein the switch is a mobile programmable switch.
